(19) United States
(12) Patent Application Publication
(10) Pub. No.: US 2023/0238228 A1
(43) Pub. Date: Jul. 27, 2023

(54) MASS SPECTROMETER

(71) Applicant: ASCEND DIAGNOSTICS LIMITED, Manchester (GB)

(72) Inventors: Simone PANTALEI, Manchester (GB); Alex GWEN-HAM HO, Manchester (GB)

(21) Appl. No.: 17/999,270

(22) PCT Filed: May 18, 2021
(86) PCT No.: PCT/GB2021/051185

§ 371 Date: Nov. 18, 2022

(30) Foreign Application Priority Data
May 18, 2020 (GB) 2007310.2

(51) Int. Cl. H01J 49/00; H01J 49/04; G01N 27/622

(52) U.S. Cl. CPC H01J 49/0031; H01J 49/0409; G01N 27/622; H01J 49/0004

(57) ABSTRACT

A mass spectrometer, MS, 100 is described. The MS 100 comprises: a first chamber 110, comprising a set of ports P close able by respective doors, for receiving sample plates including respective unique device identifiers, UDIs, therein and/or there through, wherein the set of ports P includes a first port P1 having a first door D1 and a second port P2 having a second door D2; a second chamber 120, fluidically couple able with the first chamber 110 via the second port P2, wherein the second chamber 120 is fluidically coupled to and/or comprises an ion source 130, an analyser 140 and an ion detector 150, for mass spectrometry of samples included on the sample plates received therein; and an imager 160, coupled to the second chamber 120, configured to image the UDIs of the sample plates; a controller 170 configured to control the imager 160; wherein the MS 100 is arrangeable in: a first arrangement, wherein a first sample plate 1A of a set of sample plates 1 is received in the first chamber 110 via the first port P1, wherein the first door D1 is open and wherein the second door D2 is closed, and wherein the first sample plate 1A includes a first UDI U1A of a set of UDIs; a second arrangement, wherein the first sample plate 1A is in the first chamber 110, wherein the first door D1 is closed and wherein the second door D2 is closed; and a third arrangement, wherein the first sample plate 1A is received in the second chamber 120 via the second port P2, wherein the second door D2 is closed; wherein the controller 170 is configured to control the imager 160 to image the first UDI U1A of the first sample plate 1A, when the MS 100 is arranged in the third arrangement.

### FIELD

The present invention relates to a mass spectrometer and a method of controlling a mass spectrometer, particularly to identification of samples for analysis thereby.

### BACKGROUND TO THE INVENTION

Typically, biological, for example clinical, samples for matrix-assisted laser desorption/ionization, MALDI, mass spectrometry, MS, are deposited, manually and individually by an operator, into respective wells on sample plates (also known as target plates). Generally, the sample plates are uniquely identified, for example with a unique device identifier, UDI. Generally, the wells are arranged in regular arrays and a position of a specific well may be identified by row and column. Usually, the operator is directed to deposit a particular sample into a particular well, identified by its position, on a particular sample plate, for example according to a sample list for the particular sample plate. The sample list may be provided according to the UDI of the particular sample plate, for example responsive to the operator scanning the UDI. Following deposition of the particular sample, the operator may be required to confirm that the particular sample was deposited into the particular sample well on the particular sample plate. In this way, traceability of the samples to particular wells on particular sample plates may be provided. During MALDI MS analysis, the samples deposited on the sample plates are analysed, individually (including specifically according to the particular sample) and automatically (for example, under computer control), and respective MS results thus obtained may be associated with the samples, via their particular well positions on particular sample plates. In this way, traceability of the MS results to the samples may be provided. In this way, diagnosis for and treatment of a given patient, according to corresponding MALDI MS sample analysis, may be provided.

However, this traceability may be compromised due to errors, typically human errors, and/or malicious actions, thereby adversely affecting patient safety and/or outcome. In this context, an error is accidental while a malicious action is deliberate. Nevertheless, both errors and malicious actions may result in incorrect diagnosis for and/or treatment of a given patient. To mitigate these errors and/or malicious actions, safeguards may be provided. For example, the operator may deposit the particular sample into the particular well but accidentally or deliberately on a different sample plate. In such as case, all of the samples deposited on the different sample plate may be incorrectly deposited and hence all of the MS results are incorrectly associated with different samples. To mitigate such an error, an imager may be provided to image the UDI of the sample plate onto which the particular sample will be deposited by the operator. For example, the operator may deposit the particular sample accidentally or deliberately into a different well, rather than into the particular well. Often, such an error may cascade, such that the operator deposits some or all of the samples incorrectly, for example into systematically offset wells in adjacent rows or columns. In such a case, one, some or all of the MS results are incorrectly associated with different samples. To mitigate such an error, a laser pointer may be provided to highlight the particular well. For example, the operator may accidentally or deliberately load a different sample plate, rather than the particular sample plate, into the MALDI MS. In such a case, all of the MS results are incorrectly associated with different samples. To mitigate such an error, an imager may be provided to image the UDI of the sample plate to be loaded into the MALDI MS. Nevertheless, despite providing such safeguards, accidental errors may still occur while deliberate malicious actions may still be taken.

Hence, there is a need to improve sample traceability, for example for MALDI MS of biological, for example clinical, samples.

### SUMMARY OF THE INVENTION

It is one aim of the present invention, amongst others, to provide a mass spectrometer and a method of controlling a mass spectrometer which at least partially obviates or mitigates at least some of the disadvantages of the prior art, whether identified herein or elsewhere. For instance, it is an aim of embodiments of the invention to provide a mass spectrometer and a method of controlling a mass spectrometer that improve sample traceability, for example traceability of the MS results to the samples. For instance, it is an aim of embodiments of the invention to provide a mass spectrometer and a method of controlling a mass spectrometer that more effectively safeguards from accidentally or deliberately loading a different sample plate, rather than a particular sample plate, into the MS.

A first aspect provides a mass spectrometer, MS, comprising:

a first chamber, comprising a set of ports closeable by respective doors, for receiving sample plates including respective unique device identifiers, UDIs, therein and/or therethrough, wherein the set of ports includes a first port having a first door and a second port having a second door;

a second chamber, fluidically coupleable with the first chamber via the second port, wherein the second chamber is fluidically coupled to and/or comprises an ion source, an analyser and an ion detector, for mass spectrometry of samples included on the sample plates received therein; and

an imager, coupled to the second chamber, configured to image the UDIs of the sample plates;

a controller configured to control the imager;

wherein the MS is arrangeable in:

a first arrangement, wherein a first sample plate of a set of sample plates is received in the first chamber via the first port, wherein the first door is open and wherein the second door is closed, and wherein the first sample plate includes a first UDI of a set of UDIs;

a second arrangement, wherein the first sample plate is in the first chamber, wherein the first door is closed and wherein the second door is closed; and

a third arrangement, wherein the first sample plate is received in the second chamber via the second port, wherein the second door is closed;

wherein the controller is configured to control the imager to image the first UDI of the first sample plate, when the MS is arranged in the third arrangement.

A second aspect provides a method of controlling a mass spectrometer, MS, according to the first aspect, the method comprising:

arranging the MS in a first arrangement, comprising opening the first door while the second door is closed and receiving a first sample plate of a set of sample plates in the first chamber via the first port, wherein the first sample plate includes a first UDI of a set of UDIs;

arranging the MS in a second arrangement, comprising closing the first door, wherein the first sample plate is in the first chamber, wherein the second door is closed;

arranging the MS in a third arrangement, comprising opening the second door, receiving the first sample plate in the second chamber via the second port and closing the second door thereafter; and

imaging, by the imager, the first UDI of the first sample plate, when the MS is arranged in the third arrangement.

A third aspect provides a computer comprising a processor and a memory configured to implement, at least in part, a method according to the second aspect.

A fourth aspect provides a computer program comprising instructions which, when executed by a computer comprising a processor and a memory, cause the computer to perform, at least in part, a method according to the second aspect.

A fifth aspect provides a non-transient computer-readable storage medium comprising instructions which, when executed by a computer comprising a processor and a memory, cause the computer to perform, at least in part, a method according to the second aspect.

A sixth aspect provides a mass spectrometer, MS, comprising:

a set of chambers, for receiving sample plate holders therein and/or therethrough, wherein the sample plate holders are arranged to hold respective subsets of sample plates therein and/or thereon and wherein the sample plate holders include respective identifiers, wherein the set of chambers is fluidically coupled to and/or comprises an ion source, an analyser and an ion detector, for mass spectrometry of samples included on the sample plates received therein;

a reader configured to read a first identifier, of a set of identifiers, included on a first sample plate holder, of a set of sample plate holders, optionally including a first sample plate, of a set of sample plates, held therein and/or thereon, received in the set of chambers; and

a controller configured to control the reader to read the first identifier of the first sample plate holder received in the set of chambers.

A seventh aspect provides a method of controlling a mass spectrometer, MS, according to the sixth aspect, the method comprising:

receiving the first sample plate holder in the set of chambers; and

reading the first identifier of the first sample plate holder received in the set of chambers.

An eighth aspect provides a computer comprising a processor and a memory configured to implement, at least in part, a method according to the seventh aspect.

A ninth aspect provides a computer program comprising instructions which, when executed by a computer comprising a processor and a memory, cause the computer to perform, at least in part, a method according to the seventh aspect.

A tenth aspect provides a non-transient computer-readable storage medium comprising instructions which, when executed by a computer comprising a processor and a memory, cause the computer to perform, at least in part, a method according to the seventh aspect.

An eleventh aspect provides a sample plate holder arranged to hold a subset of sample plates therein and/or thereon, wherein the subset includes N sample plates, wherein N is a natural number greater than or equal to 1, and wherein the first sample plate holder includes a first identifier of a set of identifiers.

A twelfth aspect provides a kit of parts comprising a sample plate holder according to the eleventh aspect and a sample plate.

### DETAILED DESCRIPTION OF THE INVENTION

According to the present invention there is provided a MS, as set forth in the appended claims. Also provided is a method of controlling a MS, a computer, a computer program and a non-transient computer-readable storage medium. Other features of the invention will be apparent from the dependent claims, and the description that follows.

Mass Spectrometer

The first aspect provides a mass spectrometer, MS, comprising:

a first chamber, comprising a set of ports closeable by respective doors, for receiving sample plates including respective unique device identifiers, UDIs, therein and/or therethrough, wherein the set of ports includes a first port having a first door and a second port having a second door;

a second chamber, fluidically coupleable with the first chamber via the second port, wherein the second chamber is fluidically coupled to and/or comprises an ion source, an analyser and an ion detector, for mass spectrometry of samples included on the sample plates received therein; and

an imager, coupled to the second chamber, configured to image the UDIs of the sample plates;

a controller configured to control the imager;

wherein the MS is arrangeable in:

a first arrangement, wherein a first sample plate of a set of sample plates is received in the first chamber via the first port, wherein the first door is open and wherein the second door is closed, and wherein the first sample plate includes a first UDI of a set of UDIs;

a second arrangement, wherein the first sample plate is in the first chamber, wherein the first door is closed and wherein the second door is closed; and

a third arrangement, wherein the first sample plate is received in the second chamber via the second port, wherein the second door is closed;

wherein the controller is configured to control the imager to image the first UDI of the first sample plate, when the MS is arranged in the third arrangement.

In this way, the first UDI of the first sample plate is imaged by the imager when the MS is arranged in the third arrangement and hence when the first sample plate is received in the closed second chamber. It should be understood that by imaging the first UDI, the first UDI is thereby decoded i.e. the first UDI is read. Thus, the first sample plate may be identified via the first UDI before, during and/or after mass spectrometry of the samples included on the first sample plate, without possibility of accidental or deliberate user intervention. Hence, direct correspondence between mass spectrometry of the samples included on the first sample plate and identity of the first sample plate is provided. In this way, sample traceability, for example traceability of the MS results to the samples, is improved. In this way, accidental or deliberate loading a different sample plate, rather than a particular sample plate, into the MS is safeguarded. Particularly, by imaging the first UDI of the first sample plate by the imager when the MS is arranged in the third arrangement, accidental or deliberate loading of a different sample plate is mitigated since the first UDI read by the imager is of the sample plate currently in the second chamber and hence the MS results are correctly associated with the samples on the first sample plate, rather than, for example, with a different sample plate identified, including by imaging of the respective UDI, prior to or upon loading of that different sample plate into the first chamber.

Mass Spectrometer

The first aspect provides the MS. In one example, the MS comprises and/or is a time of flight, TOF MS. In one example, the TOF MS comprises and/or is a linear TOF MS, for example having a linear flight tube arranged between the second set of electrodes and the ion detector. In one example, the TOF MS comprises and/or is a reflectron TOF MS, for example having a reflectron arranged between the second set of electrodes and the ion detector.

Set of Chambers

In one example, the MS comprises a set of chambers, including the first chamber and the second chamber.

First Chamber

The MS comprises the first chamber, comprising a set of ports closeable by respective doors, for receiving the sample plates therein and/or therethrough, wherein the set of ports includes the first port having the first door and the second port having the second door. The first chamber is fluidically coupleable with the first chamber via the second port. It should be understood that the first chamber provides an airlock (also known as a load lock), for transfer of the sample plates to and from the second chamber via the second port. In use, to load a sample plate, the second door is closed, thereby isolating the second chamber from the first chamber, and the first chamber is vented to ambient pressure (i.e. about 1 bar), such that the first door may be opened. The first door is opened and the sample plate is inserted into the first chamber via the first port by an operator, typically onto a conveyor in the first chamber, whereby the sample plate is received in the first chamber. The first door is closed and the first chamber is evacuated to a pressure compatible with that of the second chamber, such that the second door may be opened. These steps may be controlled by the controller, for example. In use, to unload the sample plate by removing the sample plate from the first chamber, similar steps are performed mutatis mutandis.

Since the operator is permitted to insert and to remove sample plates into and from the first chamber respectively via the first port when the first door is open, imaging of UDIs included on the sample plates during and/or upon insertion may not sufficiently safeguard from accidental errors and/or deliberate malicious actions. For example, a sample plate may be initially inserted and identified via its respective UDI but subsequently replaced, accidentally or deliberately, with a different sample plate. For example, the sample plate may be inserted at least partially into the first chamber, its respective UDI read but the sample plate removed before a different sample plate inserted, without imaging of its respective UDI. For example, two sample plates may be stacked, both inserted together and subsequently, after imaging of the respective UDI of the upper sample plate, the upper sample plate removed. In such cases, all of the MS results of the samples are incorrectly associated with the identified sample plate rather than the sample plate currently in the MS during the mass spectrometry of the samples included on that current sample plate.

In one example, the first chamber comprises a first conveyor (also known as a transporter), for conveying the first sample plate from the first chamber to the second chamber via the second port and optionally, vice versa. In this way, the first sample plate may be moved between the first chamber and the second chamber, for example automatically. In one example, the controller is configured control the first conveyor. It should be understood that conveying the first sample plate from the first chamber to the second chamber via the second port and optionally, vice versa, may only be performed when the second door is open. In this way, the first sample plate may be moved between the first chamber to the second chamber under control of the controller, for example without direct operator intervention. In one example, the first conveyor comprises a 1D translator such as an x stage translator for example a linear actuator such as a screw thread or a belt drive, for conveying the first sample plate from the first chamber to the second chamber by the second port and optionally, vice versa.

In one example, the set of ports includes only the first port having the first door and the second port having the second door. That is, the chamber thus may not include any other ports for the sample plates.

Sample Plates

Generally, a sample plate (also known as a target plate) is a generally rectangular or square flat plate, for example having mutually parallel upper and lower surfaces, formed from stainless steel or a polymeric composition comprising a polymer having a conductive coating thereon for example, having an array, typically a regular array, of wells (i.e. concavities) in a first portion of an upper surface thereof, relatively more proximal a first end of the sample plate, for deposition of respective samples therein. A position of a specific well may be identified by row and column, which are typically labelled alphanumerically. Typically, a second portion of the upper surface, relatively more proximal a second end of the sample plate, mutually opposed to the first end, has no wells therein, for holding of the sample plate by an operator. To limit degrees of freedom when inserting a sample plate into a mass spectrometer, for example, the sample plate may have an asymmetric shape. A UDI may included in the second portion of the upper surface. Additionally and/or alternatively, the UDI may be included on the lower surface.

In one example, the first sample plate is a generally rectangular or square flat plate, for example having mutually parallel upper and lower surfaces, formed from stainless steel or a polymeric composition comprising a polymer having a conductive coating thereon for example, having an array, for example a regular array, of wells in a first portion of an upper surface thereof, relatively more proximal a first end of the first sample plate, for deposition of respective samples therein. In one example, the first sample plate includes human-readable, for example alphanumeric, labels to identify positions of the wells by row and column. In one example, a second portion of the upper surface, relatively more proximal a second end of the first sample plate, mutually opposed to the first end, has no wells therein, for holding of the first sample plate by an operator. In one example, the first sample plate has an asymmetric shape, having a reduced number of planes of symmetry, for example a single plane of symmetry, or no planes of symmetry, orthogonal to the upper surface. In one example, the first UDI is included, for example by printing, as a label, or engraving, in the second portion of the upper surface of the first sample plate. Additionally and/or alternatively, in one example, the first UDI is included on the lower surface of the first sample plate. In one example, the first sample plate is a single-use sample plate, not intended for reuse. In one example, the first sample plate is a multi-use sample plate, intended for reuse, for example following appropriate cleaning. In one example, a thickness, a flatness and/or a parallelism of the first sample plate is within 0.05 mm, preferably within 0.04 mm, more preferably within 0.03 mm. In this way, a height of the first sample plate, for example of an upper surface thereof, may be arranged during MS analysis, for example for focusing a laser thereon and/or controlling a path length, or a part thereof, of the MS.

The sample plates include respective unique device identifiers, UDIs.

The Food and Drug Administration (FDA) established an unique device identification system, UDIS, to identify medical devices, sold in the United States, from manufacturing through distribution to patient use. Under the UDIS, medical device labels include a unique device identifier (UDI) in human- and machine-readable form. Medical device information corresponding to the UDI is submitted to a Global Unique Device Identification Database (GUDID). In this way, patient safety may be improved, device postmarket surveillance modernized, and medical device innovation facilitated through traceability conferred by the UDIs.

A UDI is an unique numeric or alphanumeric code that typically includes:
1. Device identifier (DI): a mandatory, fixed portion of the UDI that identifies the labeler and the specific version or model of a device;
2. Production identifier (PI): a conditional, variable portion of the UDI that identifies one or more of the following when included on the label of the device:
   i. Lot or batch number within which the device was manufactured;
   ii. Serial number of the specific device;
   iii. Expiration date of the specific device;
   iv. Date the specific device was manufactured;
   v. Distinct identification code required by § 1271.290(c) for a human cell, tissue, or cellular and tissue-based product (HCT/P) regulated as a device.

The device labeler must provide the UDI in two forms on labels and packages:
1. Easily readable plain-text
2. Machine-readable form that uses automatic identification and data capture (AIDC) technology.

Automatic identification and data capture, AIDC, is any technology that conveys the UDI or the device identifier of a device in a form that may be entered into an electronic patient record or other computer system via an automated process.

In addition, the device labeler must include dates on device labels and packages in a standard format that is consistent with international standards and international practice (YYYY-MM-DD). The European Commission through European Medicines Agency (EMA) and the International Medical Device Regulator Forum (IMDRF) have established similar requirements as the FDA.

Sample plates, classified as medical devices, require respective UDIs to include a company number, an item reference number and a batch/lot number. In addition, once a sample has been deposited on a sample plate, traceability of the sample plate is required and so an unique serial number for the sample plate is also required.

In one example, the UDIs comprise and/or are barcodes for example 1D barcodes or 2D barcodes such as QR codes or Data Matrix codes, preferably 2D barcodes. In one example, the first UDI comprises and/or is a barcode, for example a 1D barcode or a 2D barcode such as a QR code or a Data Matrix, preferably a 2D barcode.

A barcode represents data in a visual, machine-readable form. One-dimensional (1D) or linear barcodes represent data by varying widths and spacings of parallel lines or bards and may be scanned using optical scanners, known as barcode readers. Two-dimensional (2D) barcodes use rectangles, dots, hexagons and other geometric patterns and may be known as matrix codes. Barcodes may be read using a reader including an imager such as a camera and decoded using software, for example image recognition and barcode decoding software. In this context, 2D barcodes are preferred due to their increased data storage capacity compared with 1D barcodes.

Numerous 1D barcode standards are known, including conforming with international ISO/IEC standards, for example. 1D barcode standards include: China Postal Code, UK Plessey Code, Industrial 2 of 5, Matrix 2 of 5m Interleaved 2 of 5, Code 128, TELEPEN, EAN/UCG/GS1-128, CODABAR, ABC-CODABAR, UPC-A, UPC-E, EAN-8, EAN-13, MSI, IATA, CODE 39, CODE 11, CODE 93, GS1 Databar, GS1 Databar Stacked, GS1 Databar Limited, GS1 Databar Expanded and GS1 Databar Expanded Stacked.

Numerous 2D barcodes are known, including conforming with international ISO/IEC standards, for example. 2D barcode standards include: PDF417, Data Matrix, QR code, Micro QR code, AZTEC, Code 1, DotCode and Snowflake code. PDF417, Data Matrix, QR code, AZTEC, Code 1, DotCode and Snowflake code may be used for pharmaceutical labels, amongst other applications.

A QR code is a two-dimensional code or symbol comprising a plurality of cells, each of said plurality of cells representing a binary-coded datum; said plurality of cells forming a two-dimensional matrix pattern readable by a scanning operation along any arbitrary scanning lines; and at least three positioning symbols disposed at predetermined positions in said two-dimensional matrix pattern, at least two of said at least three positioning symbols having a pattern capable of gaining an identical frequency component ratio irrespective of an orientation of said any arbitrary scanning lines whenever said arbitrary scanning lines pass through a center of each of said at least three positioning symbols. The amount of data that can be stored in a QR code depends on the datatype (mode, or input character set), version (1, . . . , 40, indicating the overall dimensions of the symbol, i.e. 4×version number+17 dots on each side), and error correction level. The maximum storage capacity for version 40 and error correction level L (low), denoted by 40-L, is 2956 bytes.

A Data Matrix code is a two-dimensional code or symbol, comprising black and white cells arranged in either a square or a rectangular pattern, also known as a matrix. Depending on the coding used, a white cell represents 0 and a black cell represents 1, or vice versa. Every Data Matrix code includes two solid adjacent borders in an L shape (known as the finder pattern) and other two adjacent borders comprise alternating black and white cells (known as the timing pattern”. Within these borders are rows and columns of cells encoding the information. Information encoded by the Data Matrix code may include text and/or numeric data. Code sizes vary from 10×10 to 144×144 in the new version ECC 200, and from 9×9 to 49×49 in the old version ECC 000-140. The amount of data that can be stored in a Data Matrix code may be from a few bytes up to 1,556 bytes—the Data Matrix code can store up to 2,335 alphanumeric characters. Error correction codes are often used to increase reliability.

In one example, the MS comprises, in use, the first sample plate. In one example, the MS comprises the first sample plate.

Second Chamber

The MS comprises the second chamber, fluidically coupleable with the first chamber via the second port. It should be understood that the second chamber is fluidically coupled with the first chamber via the second port when the second door is open. It should be understood that the second chamber is fluidically isolated from the first chamber via the second port when the second door is closed. In this way, access to the second chamber is restricted. In this way, access to sample plates received in the second chamber is restricted. Particularly, access by the operator to the first sample plate received in the second chamber when the MS is arranged in the third configuration is prevented.

The second chamber is fluidically coupled to and/or comprises the ion source, the analyser and the ion detector, for mass spectrometry of the samples included on the sample plates received therein, as described below. It should be understood that the second chamber provides an analysis chamber, for mass spectrometry of the samples included on the sample plates, during which the second door is closed. In use, the second chamber is maintained at vacuum, for example at an operating pressure of at most 5×10⁻⁶ mbar.

In one example, the second chamber comprises a second conveyor, for conveying the first sample plate within the second chamber, for example relative to the imager. In this way, the first sample plate may be positioned, for example in a predetermined position, by the second conveyor for imaging of the first UDI by the imager. If imaging of the first UDI fails, this may indicate absence of the first sample plate in the second chamber or an incorrect orientation of the first sample plate therein. For example, even if the first sample plate is asymmetric, as described previously, it may possible for the operator to somehow still load the first sample plate into the first chamber in an incorrect orientation, for example rotated through 900 or 180°. Similarly, the first sample plate may be positioned, for example in a predetermined position, by the second conveyor for analysis of a particular sample in a particular well. In one example, the first conveyor and the second conveyor are independent. In one example, the first conveyor and the second conveyor are integrated (i.e. combined). In one example, the second conveyor comprises a 2D translator such as an x-y stage translator for example orthogonal linear actuators such as screw threads or belt drives, for conveying the first sample plate within the second chamber.

Ion Source, Analyser, Ion Detector

The second chamber is fluidically coupled to and/or comprises the ion source, the analyser and the ion detector, for mass spectrometry of the samples included on the sample plates received therein. Mass spectrometry is known.

The ion source is for desorbing and/or ablating and ionizing samples included on the sample plates, thereby supplying ions. In one example, the ion source is a vacuum ion source, for example a LDI, a MALDI, a SALDI or a LAESI ion source. In one example, the ion source comprises and/or is a pulsed ion source, for example a pulsed laser ion source. In one example, the ion source comprises and/or is a LDI ion source, preferably a pulsed LDI ion source, for example a MALDI ion source or a surface assisted laser desorption/ionization, SALDI, source.

In one example, the ion source comprises and/or is laser ablation electrospray ionization, LAESI, source, a pulsed electron ionization and/or a resonance enhanced multiphoton ion source. In one example, the pulsed ion source has a pulse duration in a range from 0.1 ns to 50 ns, preferably in a range from 0.5 ns to 20 ns, more preferably in a range from 1 ns to 5 ns. In one example, the pulsed laser ion source has a wavelength in a range from 266 to 355 nm (i.e. ultraviolet). In one example, the ion source comprises and/or is an ambient ionization source for example a desorption electrospray ionization, DESI, source, a laser ablation electrospray ionization, LAESI, source, a matrix assisted laser desorption electrospray ionization, MALDESI, source or a Direct Analysis in Real Time, DART, source.

The analyser is for separating the ions, based, at least in part, on respective mass-to-charge ratios thereof. In one example, the analyser is a quadrupole analyser, a time-of-flight, TOF, analyser such as a linear or a reflectron TOF analyser, a magnetic sector analyser, an electrostatic sector analyser, a quadrupole ion trap analyser or an ion cyclotron analyser.

The ion detector is for detecting the ions. In one example, the ion detector comprises and/or is a microchannel plate, MCP, detector and/or a fast secondary emission multiplier, SEM, for example having a flat first converter plate (dynode) is flat. Other ion detectors are known. An electrical signal from the ion detector due, at least in part, to the detected ions is typically measured using a time-to-digital converter, TDC, or a fast analogue-to-digital converter, ADC.

In one preferred example, the ion source is a MALDI ion source, the analyser is a linear TOF analyser and the ion detector is a MCP detector.

Imager

The MS comprises the imager, coupled to the second chamber, configured to image the UDIs of the sample plates. Typically, imagers (also known as a scanners) include a camera for acquiring images of UDIs and software (also known as a decoder) for image recognition and/or UDI decoding. Suitable imagers and decoders are known. It should be understood that by imaging the first UDI, the first UDI is thereby decoded i.e. the first UDI is read. It should be understood that in this context, reading the UDIs comprises imaging and decoding the UDIs. In one example, the imager is configured to decode the first UDI from the image. In one example, the controller is configured to decode the first UDI from the image.

In one example, the imager comprises and/or is a UDI reader. In one example, the imager comprises and/or is a 1D and/or a 2D reader, for example a 1D and/or a 2D barcode reader. In this way, UDIs comprising 1D and/or 2D barcodes may be read. In one example, the imager is configured to image the UDIs of the sample plates, wherein the UDIs conform with one or more 1D and/or 2D barcode standards, as described previously. Particularly, different sample plates may include UDIs conforming with different standards. In this way, the imager may read these different UDIs.

In one example, the imager is configured to transmit an image of the first UDI to the controller.

In one example, the imager is configured to decode the image of the first UDI. In one example, the imager is configured to transmit data corresponding to the first UDI to the controller. In this way, the controller may control of the MS based, at least in part, on the first UDI. More generally, in one example, the controller is configured to control the imager and/or the controller and the imager are communicatively coupled, for example bidirectionally.

The imager is coupled to the second chamber. In one example, the imager is provided within, for example at least partially within, the second chamber.

In one example, the imager is optically coupled to the second chamber. That is, the imager may be provided outside of the second chamber. In this way, a cost and/or a complexity is reduced since the imager may be exposed to ambient pressure, rather than the operating pressure of the second chamber. That is, vacuum compatibility of the imager is thus not required.

In one example, the imager is optically coupled to the second chamber via an optical coupling, for example a window or an optical fibre.

Generally, the optical coupling has a sufficiently high transmissivity (for example, at least 85%) in the spectrum range of interest (for example 635 nm-690 nm in case of standard visible UDI codes or UV or IR spectra in the case of invisible UDI symbols printed with fluorescence-based inks, for example). In one example, the optical coupling, for example a window, has a transmissivity of at least 85% in a range from 635 nm-690 nm. In one example, the optical coupling, for example a window, has a coating, for example an antireflective coating, provided on one or both sides thereof. In this way, reflectivity may be reduced, for example to just 1% in the spectrum range of interest. In one example, the optical coupling, for example a window, comprises and/or is formed from a polymeric composition comprising a polymer, a glasses and/or a crystal, such as: polymethyl methacrylate (PMMA), allyl diglycol carbonate (ADC, CR-39), chemically strengthened glass, borosilicate glass, barium borate, barium fluoride, calcite, calcium fluoride, F2 flint glass, magnesium fluoride, N-BK7, N-SF11, rutile, sapphire, UV-grade fused silica, yttrium orthovanadate and/or zinc selenide. In one example, the optical coupling, for example a window, is provided in a wall of the second chamber.

Controller

The MS comprises the controller configured to control the imager. Typically, controllers for MS are implemented using a combination of electronics, firmware and/or software, for example using a computer comprising a processor and a memory, as understood by the skilled person. In one example, the controller is configured to receive an image of a UDI, for example the first UDI, from the imager. In one example, the controller is configured to decode an image of a UDI, for example the first UDI, received from the imager.

In one example, the controller is configured to control the ion source, the analyser and/or the ion detector, for example to control mass spectrometry of the samples included on the first sample plate. Control of mass spectrometry is known.

In one example, the controller is configured to control moving from the first arrangement to the second arrangement, from the second arrangement to the third arrangement, and/or vice versa, for example responsive to instructions received from a user. In one example, the controller is configured to conditionally control moving from the first arrangement to the second arrangement, from the second arrangement to the third arrangement, and/or vice versa, for example based on presence or absence of a sample plate in the first chamber and/or second chamber and/or respective pressures in the first chamber and/or second chamber. Generally, at most one sample plate holder may be received in the second chamber. In one example, the controller is configured to control opening and/or closing of the first door and/or the second door. In one example, the controller is configured to deny a request to open the first door and the second door in use, whereby the first door and the second door are open, at least partially, simultaneously. In this way, access to the second chamber via the first chamber from outside the MS is prevented, while also preventing venting of the second chamber in use, for example.

First Arrangement

The MS is arrangeable in the first arrangement, wherein the first sample plate of the set of sample plates is received in the first chamber via the first port, wherein the first door is open and wherein the second door is closed, and wherein the first sample plate includes the first UDI of the set of UDIs.

The first arrangement may be known as a loading or unloading arrangement, in which the first sample plate may be inserted via the first port chamber or removed therefrom. It should be understood that in the first arrangement, the first chamber is at ambient pressure. In contrast, in the first arrangement, the second chamber is generally maintained at vacuum, for example at an operating pressure of at most 5×10⁻⁶ mbar.

Second Arrangement

The MS is arrangeable in the second arrangement, wherein the first sample plate is in the first chamber, wherein the first door is closed and wherein the second door is closed.

The second arrangement may be known as a transfer arrangement, in which the first sample plate, in the first chamber, may be subsequently received in the second chamber. Alternatively, the first plate is previously received in the first chamber from the second chamber before moving the MS to the first arrangement for removing the first sample plate therefrom. It should be understood that to move the MS from the second arrangement to the first arrangement, the first chamber is vented to ambient pressure, such that the first door may be opened. It should be understood that to move the MS from the second arrangement to the third arrangement, the first chamber is evacuated to a pressure compatible with that of the second chamber, for example about 5 mbar, such that the second door may be opened.

Third Arrangement

The MS is arrangeable in the third arrangement, wherein the first sample plate is received in the second chamber via the second port, wherein the second door is closed.

The third arrangement may be known as an analysis arrangement, for mass spectrometry of samples included on the first sample plate. It should be understood that in the third arrangement, the second chamber is generally maintained at vacuum, for example at an operating pressure of at most 5×10⁻⁶ mbar. In contrast, in the third arrangement, the first chamber may be at ambient pressure, at a pressure compatible with that of the second chamber, for example about 5 mbar, or at an intermediate pressure, for example between about 5 mbar and ambient pressure, if the first chamber is being vented or evacuated.

The controller is configured to control the imager to image the first UDI of the first sample plate, when the MS is arranged in the third arrangement.

In this way, the first UDI of the first sample plate is read (i.e. imaged and decoded) by the imager when the MS is arranged in the third arrangement and hence when the first sample plate is received in the closed second chamber. Thus, the first sample plate may be identified via the first UDI before, during and/or after mass spectrometry of the samples included on the first sample plate, without possibility of accidental or deliberate user intervention. Hence, direct correspondence between mass spectrometry of the samples included on the first sample plate and identity of the first sample plate is provided. In this way, sample traceability, for example traceability of the MS results to the samples, is improved. In this way, accidental or deliberate loading a different sample plate, rather than a particular sample plate, into the MS is safeguarded.

In one example, the controller is configured to control the imager to image the first UDI of the first sample plate, when the MS is arranged in the third arrangement, responsive to the MS moving to the third arrangement. In this way, imaging of the first UDI of the first sample plate may be automated. In one example, the controller is configured to control the imager to image the first UDI of the first sample plate responsive to sensing the first sample plate in the second chamber. In one example, the controller is configured to control the imager to image the first UDI of the first sample plate, in response to sensing closing of the second door, sensing receiving of the first sample plate in the second chamber and/or sensing a pressure in the second chamber.

In one example, the MS comprises a set of sensors communicatively coupled to the controller, wherein the set of sensors optionally includes a first sensor such as a microswitch for sensing closing of the second door, a second sensor such as a microswitch for sensing receiving of the first sample plate in the second chamber and/or a third sensor such as a pressure sensor for sensing a pressure in the second chamber.

In one example, the controller is configured to control the imager to attempt to image a UDI of a sample plate intermittently, periodically and/or continuously, for example even if the first sample plate is not in the second chamber. In this way, the first sample plate may be sensed in the second chamber based on imaging the first UDI of the first sample plate.

In one example, the controller is configured to control the imager to image the first UDI of the first sample plate intermittently, periodically and/or continuously. In this way, an identity of the first sample plate may be confirmed, for example repeatedly.

In one example, the controller is configured to control the imager to image the first UDI of the first sample plate, when the MS is arranged in the third arrangement, before, during and/or after mass spectrometry of the samples included on the first sample plate. By imaging the first UDI of the first sample plate before mass spectrometry of the samples included on the first sample plate, the mass spectrometry of one or more of these samples may be performed specifically, for example using sample-specific methods and/or parameters.

In one example, the controller is configured to control mass spectrometry of the samples included on the first sample plate based, at least in part, on information obtained via the first UDI. In one example, the controller is configured to obtain the information, for example locally and/or remotely such as from a database, for example using the first UDI and/or a well position, at least in part, as a key.

In one example, the information includes sample plate-specific and/or sample-specific methods and/or parameters, for mass spectrometry of one or more of the samples included on the first sample plate. In this way, the mass spectrometry of one or more of these samples may be performed specifically, for example using the sample plate-specific and/or the sample-specific methods and/or parameters.

In one example, the controller is configured to store, for example locally and/or remotely such as in a database, MS data and/or results of one or more of the samples included on the first sample plate, for example responsive to performing the mass spectrometry of one or more of the samples included on the first sample plate, for example after mass spectrometry of each sample, for example using the first UDI and/or a well position, at least in part, as a key.

In one example, the controller is configured to implement a remedial action, in response to a determination that the first UDI is invalid. In one example, the remedial action comprises one or more selected from a group comprising: abort sample analysis, unload the first sample plate, request permission to continue.

Fourth Arrangement

In one example, the MS is arrangeable in a fourth arrangement, wherein the first sample plate is received in the second chamber via the second port, wherein the second door is closed and wherein the first door is open.

Sample Plate Holder

In one example, the first sample plate is held in and/or on a first sample plate holder (also known as a carrier, a frame or an adapter) of a set of sample plate holders. The first sample plate holder may be received in the MS, for example in the first chamber and/or in the second chamber, generally as described with respect to the first sample plate, mutatis mutandis. In one example, the first sample plate holder is arranged to hold a subset of sample plates therein and/or thereon, for example by having a corresponding number of female members such as concavities for receiving the subset of sample plates therein.

Conventionally, a single sample plate holder is integrated into a MS such that the sample plate holder is not removable therefrom by the operator. In contrast, the first sample plate holder may be loaded into the MS and unloaded therefrom, for example repeatedly. In this way, samples may be deposited on sample plates that are then held in and/or on the first sample plate holder, for example remote from the MS such as in another laboratory, by the operator and/or a different operator and the first sample plate holder subsequently loaded into the MS, for mass spectrometry of samples included thereon. Additionally and/or alternatively, while the first sample plate holder is loaded in the MS, other sample plates may be prepared in parallel (i.e. simultaneously) and held in and/or on a second sample plate holder, for subsequent loading into the MS. Additionally and/or alternatively, a plurality of sample plate holders may be stored an autosampler included in the MS. In this way, throughput of samples may be increased.

In one example, the first sample plate holder is a generally rectangular or square flat plate, for example having mutually parallel upper and lower surfaces, formed from stainless steel or a polymeric composition comprising a polymer having a conductive coating thereon for example, having an array, for example a regular array, of female members (also known as placeholders) in and/or on a first portion of an upper surface thereof, relatively more proximal a first end of the first sample plate holder, for receiving respective sample plates therein. In one example, each female member has a shape corresponding with a shape, for example an asymmetric shape, of a respective sample plate. In one example, each female member comprises a plurality of sidewall portions arranged to retain a respective sample plate in one or two dimensions. in one example, the sample plate holder, for example each female member, comprises a biasing member arranged to retain a respective sample plate in a female member and/or to bias the respective sample plate in a predetermined position. In one example, a sidewall portion comprises a recess, for example to facilitate inserting and/or removing the respective sample plate from the female member. In one example, the sample plater holder, for example each female member, comprises one or more seats (also known as pads) therein and/or thereon to receive a respective sample plate thereon. In this way, a height of the sample plate, for example of an upper surface thereof, may be predetermined for MS analysis, by controlling a height and/or a thickness of the seats, for example relative to an upper surface and/or a lower surface of the first sample plate holder. In one example, a thickness, a flatness and/or a parallelism of the seats is within 0.05 mm, preferably within 0.04 mm, more preferably within 0.03 mm. In this way, a height of the first sample plate, for example of an upper surface thereof, may be arranged during MS analysis, for example for focusing a laser thereon and/or controlling a path length, or a part thereof, of the MS. In one example, the first sample plate holder includes human-readable, for example alphanumeric, labels to identify positions of the female members by row and column. That is, the operator may be instructed to place a particular sample plate in a particular female member. In one example, the first sample plate holder includes no human-readable, for example alphanumeric, labels to identify positions of the female members by row and column. That is, a particular sample plate may be received in any of the female members. In this way, the operator is allowed to place any sample plate in any permissible placeholder of the first sample plate holder, thereby eliminating a risk of accidental error and/or deliberate malicious actions in handling and/or placing of the sample plates, thereby excluding the risk of incorrect sample assignment and identification. In one example, a second portion of the upper surface, relatively more proximal a second end of the first sample plate holder, mutually opposed to the first end, has no female members therein, for holding of the first sample plate holder by an operator. In one example, the first sample plate holder has an asymmetric shape, having a reduced number of planes of symmetry, for example a single plane of symmetry, or no planes of symmetry, orthogonal to an upper surface thereof. In this way, the degrees of freedom for insertion of the first sample plate holder into the MS is reduced, thereby guiding the operator to insert the first sample plate holder therein in a predetermined orientation. In one example, the first sample plate holder comprises a null UDI in a position corresponding to a position of an unique device identifier, UDI, included on a respective sample plate. In one example, one or more of the female members, for example all of the female members, include a null UDI in a position, for example a predetermined position, corresponding to the respective position of the first UDI of the first sample plate, wherein the null UDI indicates absence of a sample plate therein and/or thereon.

In this way, the imager thus reads the null UDI and thereby absence of a sample plate is confirmed. Alternatively, the imager may attempt to image a UDI at a position, for example a predetermined position, corresponding to the respective position of the first UDI of the first sample plate, wherein a null imaging (i.e. not conforming with a UDI) indicates absence of a sample plate therein and/or thereon.

In one example, the first sample plate holder is a multi-use sample plate holder, intended for reuse, for example following appropriate cleaning.

In one example, the first sample plate holder includes a first identifier of a first set of identifiers.

In this way, the first sample plate holder may be identified, generally as described with respect to the first sample plate and the first UDI.

In one example, the first identifier is included, for example by printing, as a label, or engraving, in the second portion of the upper surface of the first sample plate holder. Additionally and/or alternatively, in one example, the first identifier is included on the lower surface of the first sample plate holder.

In one example, the first identifier comprises and/or is a visual code, for example a 1D barcode or a 2D symbol, a magnetic strip, an RFID/NFC tag, an IC chip and/or a label. In contrast to sample plates, sample plate holders may not be classified as medical devices and hence the first identifier may not be required to conform to the same requirements as the first UDI, for example. In one example, the first identifier comprises and/or is a UDI. In this way, the first identifier may be read by the imager, as described with respect to the first UDI, mutatis mutandis.

In one example, the first identifier encodes information including one or more of: a type sample plate holder, a number of sample plates receivable therein and/or thereon and/or a type of sample plates receivable therein and/or thereon.

In one example, the MS comprises a reader configured to read the first identifier. A reader may be additionally and/or alternatively required if the imager is not compatible with the first identifier (i.e. if the imager cannot sense the first identifier), for example if the first identifier comprises and/or is a magnetic strip, an RFID/NFC tag, an IC chip.

In one example, the first identifier is as described with respect to the first UDI. In this way, the imager is configured to image the first identifier.

In one example, the controller is configured to control the imager to image the first identifier of the first sample plate holder, when the MS is arranged in the third arrangement. In one example, the controller is configured to control the imager to image the first UDI of the first sample plate, when the MS is arranged in the third arrangement, responsive to sensing the first identifier of the first sample plate holder. That is, the first identifier of the first sample plate holder may be read first, from information encoded a type sample plate holder, a number of sample plates held therein and/or thereon and/or a type of sample plates receivable therein and/or thereon may be determined and the first sampler plate holder conveyed to a predetermined position for imaging the first UDI.

In one example, the controller is configured to control the imager to image the first identifier of the first sample plate holder, when the MS is arranged in the third arrangement, responsive to the MS moving to the third arrangement. In this way, imaging of the first identifier of the first sample plate holder may be automated, as described with respect to the first sample plate, mutatis mutandis.

In one example, the controller is configured to control the imager to image the first identifier of the first sample plate holder intermittently, periodically and/or continuously. In this way, an identity of the first sample plate holder may be confirmed, for example repeatedly.

In one example, the controller is configured to control the imager to image the first identifier of the first sample plate holder, when the MS is arranged in the third arrangement, before, during and/or after mass spectrometry of the samples included on the first sample plate. By imaging the first identifier of the first sample plate holder before mass spectrometry of the samples included on the first sample plate, the mass spectrometry of one or more of these samples may be performed specifically, for example using sample-specific methods and/or parameters.

In one example, the controller is configured to control mass spectrometry of the samples included on the first sample plate based, at least in part, on information obtained via the first identifier. In one example, the controller is configured to obtain the information, for example locally and/or remotely such as from a database, for example using the first identifier and/or the first UDI, at least in part, as a key.

In one example, the first sample plate holder is arranged to hold a subset of the set of sample plates, wherein the subset includes N sample plates, wherein N is a natural number greater than or equal to 1, for example 1, 2, 3, 4, 5, 6, 7, 8, 9, 10 or more. In this way, one or more sample plates may be received in the MS, for example in the first chamber and/or in the second chamber, for example simultaneously.

Autosampler

In one example, the MS comprises an autosampler, arranged to store a subset of the set of sample plates and/or a subset of the set of sample plate holders therein, for example in a stacked arrangement. In one example, the subset includes M sample plate holders, wherein M is a natural number greater than or equal to 1, for example 1, 2, 3, 4, 5, 6, 7, 8, 9, 10 or more. In this way, one or more sample plate holders may be received in the MS, for example in the first chamber and/or in the second chamber, for example simultaneously. In one example, the autosampler is provided in the first chamber. In one example, the autosampler is provided in the second chamber. In one example, the first chamber comprises a sub (also known as ante) chamber, and the autosampler is provided in the sub chamber. In use, the sub chamber may be maintained at a pressure compatible with that of the second chamber, for example about 5 mbar, such that the second door may be opened. In one example, an imager and/or a reader this provided for the autosampler. In this way, sample plate holders and/or sample plates stored in the autosampler may be identified and hence locations thereof tracked.

Method of Controlling a Mass Spectrometer

A second aspect provides a method of controlling a mass spectrometer, MS, according to the first aspect, the method comprising:

arranging the MS in a first arrangement, comprising opening the first door while the second door is closed and receiving a first sample plate of a set of sample plates in the first chamber via the first port, wherein the first sample plate includes a first UDI of a set of UDIs;

arranging the MS in a second arrangement, comprising closing the first door, wherein the first sample plate is in the first chamber, wherein the second door is closed;

arranging the MS in a third arrangement, comprising opening the second door, receiving the first sample plate in the second chamber via the second port and closing the second door thereafter; and

imaging, by the imager, the first UDI of the first sample plate, when the MS is arranged in the third arrangement.

The method may include any of the steps or features described with respect to the first aspect.

Computer, Computer Program, Non-Transient Computer-Readable Storage Medium

The third aspect provides a computer comprising a processor and a memory configured to implement, at least in part, a method according to the second aspect.

The fourth aspect provides a computer program comprising instructions which, when executed by a computer comprising a processor and a memory, cause the computer to perform, at least in part, a method according to the second aspect.

The fifth aspect provides a non-transient computer-readable storage medium comprising instructions which, when executed by a computer comprising a processor and a memory, cause the computer to perform, at least in part, a method according to the second aspect.

Mass Spectrometer

The sixth aspect provides a mass spectrometer, MS, comprising:

a set of chambers, for receiving sample plate holders therein and/or therethrough, wherein the sample plate holders are arranged to hold respective subsets of sample plates therein and/or thereon and wherein the sample plate holders include respective identifiers, wherein the set of chambers is fluidically coupled to and/or comprises an ion source, an analyser and an ion detector, for mass spectrometry of samples included on the sample plates received therein;

a reader configured to read a first identifier, of a set of identifiers, included on a first sample plate holder, of a set of sample plate holders, optionally including a first sample plate, of a set of sample plates, held therein and/or thereon, received in the set of chambers; and

a controller configured to control the reader to read the first identifier of the first sample plate holder received in the set of chambers.

In this way, the first identifier of the first sample plate holder is read when the first sample plate holder is received in the set of chambers. Thus, the first sample plate holder may be identified via the first identifier before, during and/or after mass spectrometry of the samples included on the first sample plate. In this way, sample traceability, for example traceability of the MS results to the samples, is improved. Since the first sample plate holder may be loaded into the MS and unloaded therefrom, for example repeatedly, samples may be deposited on the first sample plate held therein and/or thereon, for example remote from the MS such as in another laboratory, by the operator and/or a different operator and the first sample plate holder subsequently loaded into the MS, for mass spectrometry of samples included thereon. Additionally and/or alternatively, while the first sample plate holder is loaded in the MS, other sample plates may be prepared in parallel (i.e. simultaneously) and held in and/or on a second sample plate holder, for subsequent loading into the MS. Additionally and/or alternatively, a plurality of sample plate holders may be stored an autosampler included in the MS. In this way, throughput of samples may be increased. Since the sample plate holders include respective identifiers, sample traceability is improved. For example, the location of a particular sample plate holder may be determined, based on identification thereof in the set of chambers and/or the autosampler.

The MS, the set of chambers, the sample plate holders, the sample plates, the identifiers, the ion source, the analyser, the ion detector, the mass spectrometry, the samples, the reader, the first identifier, the set of identifiers, the first sample plate holder, the set of sample plate holders, the first sample plate, the set of sample plates and/or the controller maybe as described with respect to the first aspect, mutatis mutandis.

In one example, the set of chambers comprises a first chamber, comprising a set of ports closeable by respective doors, for receiving the sample plate holders therein and/or therethrough, and wherein the set of ports includes a first port having a first door;

wherein the first chamber is fluidically coupled to and/or comprises the ion source, the analyser and the ion detector;

wherein the controller is configured to control the reader to read the first identifier of the first sample plate holder received in the first chamber.

In one example, the MS is arrangeable in:

a first arrangement, wherein the first sample plate holder is received in the first chamber via the first port, wherein the first door is open; and

a second arrangement, wherein the first sample plate holder is in the first chamber and wherein the first door is closed;

wherein the controller is configured to control the reader to read the first identifier of the first sample plate holder, when the MS is arranged in the second arrangement.

In this way, the first identifier of the first sample plate holder is read by the reader when the first door is closed, without possibility of accidental or deliberate user intervention.

In one example, the set of chambers includes:

a first chamber, comprising a set of ports closeable by respective doors, for receiving the sample plate holders therein and/or therethrough and wherein the set of ports includes a first port having a first door and a second port having a second door;

a second chamber, fluidically coupleable with the first chamber via the second port, wherein the second chamber is fluidically coupled to and/or comprises the ion source, the analyser and the ion detector;

wherein the MS is arrangeable in:

a first arrangement, wherein the first sample plate holder is received in the first chamber via the first port, wherein the first door is open and wherein the second door is closed;

a second arrangement, wherein the first sample plate holder is in the first chamber, wherein the first door is closed and wherein the second door is closed; and

a third arrangement, wherein the first sample plate holder is received in the second chamber via the second port, wherein the second door is closed;

wherein the controller is configured to control the reader to read the first identifier of the first sample plate holder, when the MS is arranged in the third arrangement.

That is, the MS may be as described with respect to the first aspect.

In this way, the first identifier of the first sample plate holder is read by the reader when the MS is arranged in the third arrangement and hence when the first sample plate holder is received in the closed second chamber. Thus, the first sample plate holder may be identified via the first identifier before, during and/or after mass spectrometry of the samples included on the first sample plate, without possibility of accidental or deliberate user intervention. In this way, sample traceability, for example traceability of the MS results to the samples, is improved. In this way, accidental or deliberate loading a different sample plate holder, rather than a particular sample plate holder, into the MS is safeguarded. Particularly, by reading the first identifier of the first sample plate holder by the reader when the MS is arranged in the third arrangement, accidental or deliberate loading of a different sample plate holder is mitigated since the first identifier read by the reader is of the sample plate holder currently in the second chamber.

The first chamber, the set of ports, the doors, the first port, the store, second report, the second door, the second chamber, the first arrangement, the second arrangement and/or the third arrangement may be as described with respect to the first aspect.

Method of Controlling a Mass Spectrometer

The seventh aspect provides a method of controlling a mass spectrometer, MS, according to the sixth aspect, the method comprising:

receiving the first sample plate holder in the set of chambers; and

reading the first identifier of the first sample plate holder received in the set of chambers.

The method may include any of the steps or features described with respect to the first aspect, the second aspect and/or the sixth aspect.

In one example, the method comprises:

arranging the MS in a first arrangement, comprising opening the first door and receiving the first sample plate holder in the first chamber via the first port; and

arranging the MS in a second arrangement, comprising closing the first door, wherein the first sample plate holder is in the first chamber; and

reading, by the reader, the first identifier of the first sample plate holder, when the MS is arranged in the second arrangement.

In one example, the method comprises:

arranging the MS in a first arrangement, comprising opening the first door while the second door is closed and receiving a first sample plate holder of a set of sample plate holders in the first chamber via the first port, wherein the first sample plate holder includes a first identifier of a set of identifiers;

arranging the MS in a second arrangement, comprising closing the first door, wherein the first sample plate holder is in the first chamber, wherein the second door is closed;

arranging the MS in a third arrangement, comprising opening the second door, receiving the first sample plate holder in the second chamber via the second port and closing the second door thereafter; and

reading, by the reader, the first identifier of the first sample plate holder, when the MS is arranged in the third arrangement.

Computer, Computer Program, Non-Transient Computer-Readable Storage Medium

The eighth aspect provides a computer comprising a processor and a memory configured to implement, at least in part, a method according to the seventh aspect.

The ninth aspect provides a computer program comprising instructions which, when executed by a computer comprising a processor and a memory, cause the computer to perform, at least in part, a method according to the seventh aspect.

The tenth aspect provides a non-transient computer-readable storage medium comprising instructions which, when executed by a computer comprising a processor and a memory, cause the computer to perform, at least in part, a method according to the seventh aspect.

The eleventh aspect provides a sample plate holder arranged to hold a subset of sample plates therein and/or thereon, wherein the subset includes N sample plates, wherein N is a natural number greater than or equal to 1, and wherein the first sample plate holder includes a first identifier of a set of identifiers.

Sample Plate Holder

The sample plate holder may be as described with respect to the first aspect and/or the sixth aspect.

Kit of Parts

The twelfth aspect provides a kit of parts comprising a sample plate holder according to the eleventh aspect and a sample plate.

The kits of parts may be as described with respect to the sixth aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person imaging this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a cross-sectional side elevation view of a mass spectrometer according to an exemplary embodiment;

FIG. 2 schematically depicts a cross-sectional plan view of the mass spectrometer of FIG. 1;

FIG. 3 schematically depicts a first sample plate for the mass spectrometer of FIG. 1;

FIG. 4 schematically depicts a first sample plate holder, for the first sample plate of FIG. 3, for the mass spectrometer of FIG. 1;

FIG. 5 schematically depicts a first sample plate for the mass spectrometer of FIG. 1;

FIG. 6 schematically depicts a first sample plate holder, for the first sample plate of FIG. 5, for the mass spectrometer of FIG. 1;

FIG. 7 schematically depicts a first sample plate for the mass spectrometer of FIG. 1;

FIG. 8 schematically depicts a first sample plate holder, for the first sample plate of FIG. 7, for the mass spectrometer of FIG. 1;

FIG. 9 schematically depicts a first sample plate for the mass spectrometer of FIG. 1;

FIG. 10 schematically depicts a first sample plate holder, for the first sample plate of FIG. 9, for the mass spectrometer of FIG. 1;

FIG. 11 schematically depicts a perspective, cutaway view of a mass spectrometer according to an exemplary embodiment;

FIG. 12 schematically depicts a method of controlling a mass spectrometer according to an exemplary embodiment; and

FIG. 13 schematically depicts a method of controlling a mass spectrometer according to an exemplary embodiment.

### DETAILED DESCRIPTION OF THE DRAWINGS

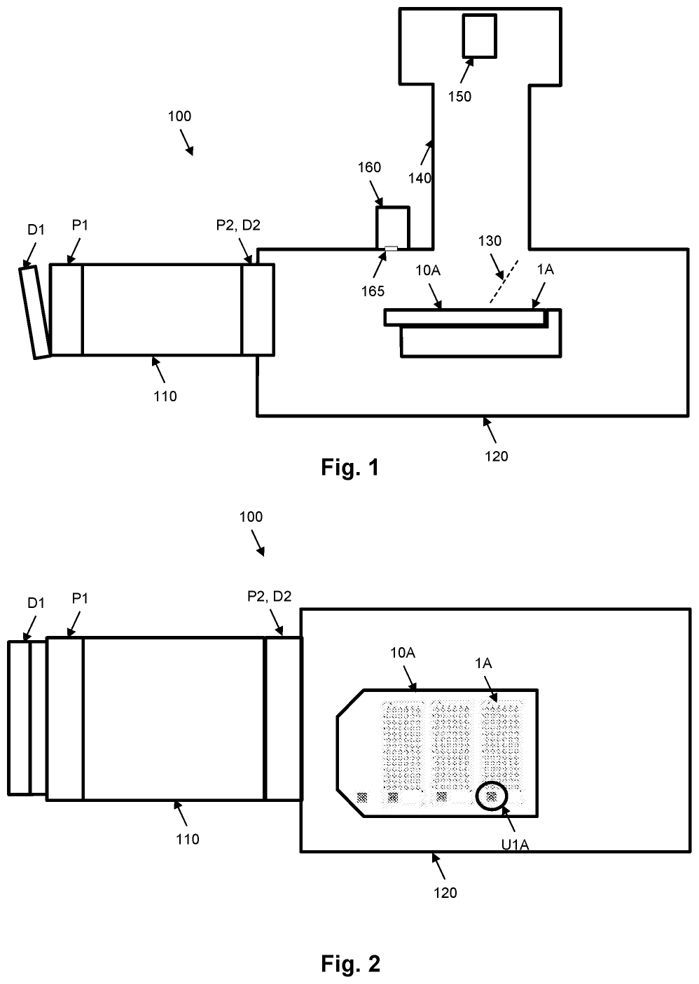

FIG. 1 schematically depicts a cross-sectional side elevation view of a mass spectrometer, MS, 100 according to an exemplary embodiment. FIG. 2 schematically depicts a cross-sectional plan view of the mass spectrometer 100 of FIG. 1.

The MS 100 comprises: a first chamber 110, comprising a set of ports P closeable by respective doors, for receiving sample plates including respective unique device identifiers, UDIs, therein and/or therethrough, wherein the set of ports P includes a first port P1 having a first door D1 and a second port P2 having a second door D2; a second chamber 120, fluidically coupleable with the first chamber 110 via the second port P2, wherein the second chamber 120 is fluidically coupled to and/or comprises an ion source 130, an analyser 140 and an ion detector 150, for mass spectrometry of samples included on the sample plates received therein; and an imager 160, coupled to the second chamber 120, configured to image the UDIs of the sample plates;

a controller 170 (not shown) configured to control the imager 160; wherein the MS 100 is arrangeable in: a first arrangement, wherein a first sample plate 1A of a set of sample plates 1 is received in the first chamber 110 via the first port P1, wherein the first door D1 is open and wherein the second door D2 is closed, and wherein the first sample plate 1A includes a first UDI U1A of a set of UDIs; a second arrangement, wherein the first sample plate 1A is in the first chamber 110, wherein the first door D1 is closed and wherein the second door D2 is closed; and

a third arrangement, wherein the first sample plate 1A is received in the second chamber 120 via the second port P2, wherein the second door D2 is closed; wherein the controller 170 is configured to control the imager 160 to image the first UDI U1A of the first sample plate 1A, when the MS 100 is arranged in the third arrangement.

FIG. 1 shows the MS arranged in a fourth arrangement.

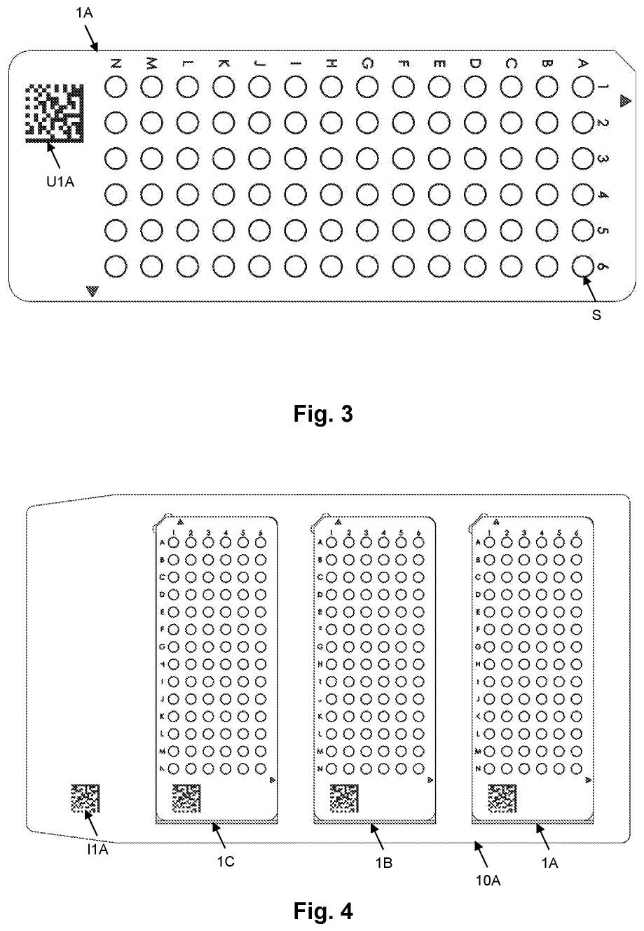

The first sample plate 1A is described with respect to FIG. 3. In this example, the first sample plate 1A is held in and/or on a first sample plate holder 10A of a set of sample plate holders 10, as described with respect to FIG. 4.

In this example, the TOF MS 100 comprises and/or is a linear TOF MS 100, for example having a linear flight tube arranged between the second set of electrodes and the ion detector 150.

In this example, the first chamber 110 comprises a first conveyor 180 (also known as a transporter), for conveying the first sample plate 1A from the first chamber 110 to the second chamber 120 via the second port P2 and optionally, vice versa. In this example, the first conveyor 180 comprises a 1D translator such as an x stage translator for example a linear actuator such as a screw thread or a belt drive, for conveying the first sample plate 1A from the first chamber 110 to the second chamber 120 by the second port P2 and optionally, vice versa. In this example, the set of ports P includes only the first port P1 having the first door D1 and the second port P2 having the second door D2.

In use, the second chamber 120 is maintained at vacuum, for example at an operating pressure of at most 5×10⁻⁶ mbar. In this example, the second chamber 120 comprises a second conveyor 190, for conveying the first sample plate 1A within the second chamber 120, for example relative to the imager 160. In this example, the ion source 130 is a MALDI ion source 130, the analyser 140 is a linear TOF analyser 140 and the ion detector 150 is a MCP detector.

In this example, a height of the first sample plate 1A, for example an upper surface thereof, is controlled using an adjustable stage, to within 0.025 mm.

In this example, the imager 160 is a 1D and a 2D barcode reader, for example a 1D and/or a 2D barcode reader. In this example, the imager 160 is configured to image the UDIs of the sample plates, wherein the UDIs conform with one or more 1D and/or 2D barcode standards, as described previously.

In this example, the imager 160 is supplied by Marson Technology Co., Ltd. and includes a MT85HD imager and a MTD20 decoder. The MT85HD imager is specified thus:

| | |
|---|---|
| CCD Camera: | 1280 × 800 pixel sensor. |
| Illumination source: | 3000K CCT LED |
| Acquisition rate: | 60 fps |
| Typical Resolution: | 0.1 mm (QR Code) |
| Pitch/Skew/Roll Angle: | ±60°/±30°/360° |
| Scan Angle Horizontal: | 37° |
| Scan Angle Vertical: | 24° |
| Print Contrast Ratio: | 30% |
| Width of Field: | 65 mm (13 Mil Code39) |
| Typical D.O.F (@800 lux): | UPC/EAN 13 Mil: 47~170 mm |
| | QR Code 15 Mil: 35~157 mm |

In this example, the imager 160 is configured to transmit data corresponding to the first UDI U1A to the controller 170. In this example, the controller 170 is configured to control the imager 160 and/or the controller 170 and the imager 160 are communicatively coupled, for example bidirectionally.

In this example, the imager 160 is optically coupled to the second chamber 120 via an optical coupling 165, particularly a window. In this example, the optical coupling 165 comprises is formed from UV-grade fused silica. In this example, the optical coupling 165 has an antireflective coating provided on both sides thereof. In this example, the optical coupling 165 is provided in a wall of the second chamber 120.

In this example, the controller 170 is configured to control the ion source 130, the analyser 140 and/or the ion detector 150, for example to control mass spectrometry of the samples included on the first sample plate 1A. In this example, the controller 170 is configured to control moving from the first arrangement to the second arrangement, from the second arrangement to the third arrangement, and/or vice versa, for example responsive to instructions received from a user. In this example, the controller 170 is configured to conditionally control moving from the first arrangement to the second arrangement, from the second arrangement to the third arrangement, and/or vice versa, for example based on presence or absence of a sample plate in the first chamber 110 and/or second chamber 120 and/or respective pressures in the first chamber 110 and/or second chamber 120. In this example, the controller 170 is configured to control opening and/or closing of the first door D1 and/or the second door D2. In this example, the controller 170 is configured to deny a request to open the first door D1 and the second door D2 in use, whereby the first door D1 and the second door D2 are open, at least partially, simultaneously. In this example, the controller 170 is configured to control the imager 160 to image the first UDI U1A of the first sample plate 1A, when the MS 100 is arranged in the third arrangement, responsive to the MS 100 moving to the third arrangement. In this example, the controller 170 is configured to control the imager 160 to image the first UDI U1A of the first sample plate 1A responsive to sensing the first sample plate 1A in the second chamber 120. In this example, the MS 100 comprises a set of sensors communicatively coupled to the controller 170, wherein the set of sensors optionally includes a first sensor such as a microswitch for sensing closing of the second door D2, a second sensor such as a microswitch for sensing receiving of the first sample plate 1A in the second chamber 120 and/or a third sensor such as a pressure sensor for sensing a pressure in the second chamber 120. In this example, the controller 170 is configured to control the imager 160 to image the first UDI U1A of the first sample plate 1A, when the MS 100 is arranged in the third arrangement, before mass spectrometry of the samples included on the first sample plate 1A. In this example, the controller 170 is configured to control mass spectrometry of the samples included on the first sample plate 1A based, at least in part, on information obtained via the first UDI U1A. In this example, the controller 170 is configured to store, for example locally and/or remotely such as in a database, MS 100 data and/or results of one or more of the samples included on the first sample plate 1A, for example responsive to performing the mass spectrometry of one or more of the samples included on the first sample plate 1A, for example after mass spectrometry of each sample, for example using the first UDI U1A and/or a well position, at least in part, as a key. In this example, the controller 170 is configured to control the imager 160 to image the first identifier of the first sample plate holder 10A, when the MS 100 is arranged in the third arrangement. In this example, the controller 170 is configured to control the imager 160 to image the first UDI U1A of the first sample plate 1A, when the MS 100 is arranged in the third arrangement, responsive to imaging the first identifier of the first sample plate holder 10A. That is, the first identifier of the first sample plate holder 10A may be read first, from information encoded a type sample plate holder, a number of sample plates receivable therein and/or thereon and/or a type of sample plates receivable therein and/or thereon may be determined and the first sampler plate holder conveyed to a predetermined position for imaging the first UDI U1A. In this example, the controller 170 is configured to control the imager 160 to image the first identifier of the first sample plate holder 10A, when the MS 100 is arranged in the third arrangement, responsive to the MS 100 moving to the third arrangement. In this example, the controller 170 is configured to control the imager 160 to image the first identifier of the first sample plate holder 10A, when the MS 100 is arranged in the third arrangement, before mass spectrometry of the samples included on the first sample plate 1A. In this example, the controller 170 is configured to control mass spectrometry of the samples included on the first sample plate 1A based, at least in part, on information obtained via the first identifier 1A. In this example, the controller 170 is configured to obtain the information, for example locally and/or remotely such as from a database, for example using the first identifier and/or the first UDI U1A, at least in part, as a key.

FIG. 3 schematically depicts a first sample plate 1A for the mass spectrometer of FIG. 1.

In this example, the first sample plate 1A is a generally rectangular flat plate, formed from a polymeric composition comprising a polymer having a conductive coating thereon, having a regular 14×5 array of wells in a first portion of an upper surface thereof, relatively more proximal a first end of the first sample plate 1A, for deposition of respective samples S therein. In this example, the first sample plate 1A includes human-readable, for example alphanumeric, labels (not shown) to identify positions of the wells by row and column. In this example, a second portion of the upper surface, relatively more proximal a second end of the first sample plate 1A, mutually opposed to the first end, has no wells therein, for holding of the first sample plate 1A by an operator. In this example, the first sample plate 1A has an asymmetric shape, having a reduced number of planes of symmetry, having a single plane of symmetry orthogonal to the upper surface. In this example, the first UDI U1A is included, for example by printing, as a label, or engraving, in the second portion of the upper surface of the first sample plate 1A. In this example, the first sample plate 1A is a single-use sample plate, not intended for reuse.

In this example, the first UDI U1A is a 2D barcode such as a QR code or a Data Matrix.

FIG. 4 schematically depicts a first sample plate holder 10A, for the first sample plate 1A of FIG. 3, for the mass spectrometer of FIG. 1.

In this example, the first sample plate holder 10A is arranged to hold a subset of a set of sample plates 1, wherein the subset includes N sample plates, wherein N is 3. In this example, three first sample plates 1A, 1B, 1C, are held in the first sample plate holder 10.

In this example, the first sample plate 1A is held in and/or on a first sample plate holder 10A (also known as a carrier) of a set of sample plate holders. In this example, the first sample plate holder 10A is arranged to hold a subset of up to 3 sample plates therein and/or thereon, by having a corresponding number of female members particularly machined concavities for receiving the subset of sample plates therein.

In this example, the first sample plate holder 10A is a generally rectangular or square flat plate, formed from stainless steel, having a regular array of 1×3 female members in and/or on a first portion of an upper surface thereof, relatively more proximal a first end of the first sample plate holder 10A, for holding respective sample plates 1 therein. In this example, each female member has a shape corresponding with a shape, for example an asymmetric shape, of a respective sample plate. In this example, the first sample plate holder 10A includes no human-readable, for example alphanumeric, labels to identify positions of the female members by row and column.

In this example, a second portion of the upper surface, relatively more proximal a second end of the first sample plate holder 10A, mutually opposed to the first end, has no female members therein, for holding of the first sample plate holder 10A by an operator. In this example, the first sample plate holder 10A has an asymmetric shape, having a reduced number of planes of symmetry, having a single plane of symmetry orthogonal to the upper surface.

In this example, the first sample plate holder 10A is a multi-use sample plate holder, intended for reuse, for example following appropriate cleaning.

In this example, the first sample plate holder 10A includes a first identifier 1A of a first set of identifiers. In this example, the first identifier 11A is included, for example by printing, as a label, or engraving, in the second portion of the upper surface of the first sample plate holder 10A.

In this example, the first identifier 1A is a 2D symbol. In this example, the first identifier 11A comprises a UDI. In this example, the first identifier 1A encodes information including one or more of: a type sample plate holder, a number of sample plates receivable therein and/or thereon and/or a type of sample plates receivable therein and/or thereon.

In this example, the first sample plate holder 10A is arranged to hold a subset of the set of sample plates 1, wherein the subset includes N sample plates 1A, 1B, 1C, wherein N is 3. In this example, three first sample plates 1A, 1B, 1C are held in the first sample plate holder 10A.

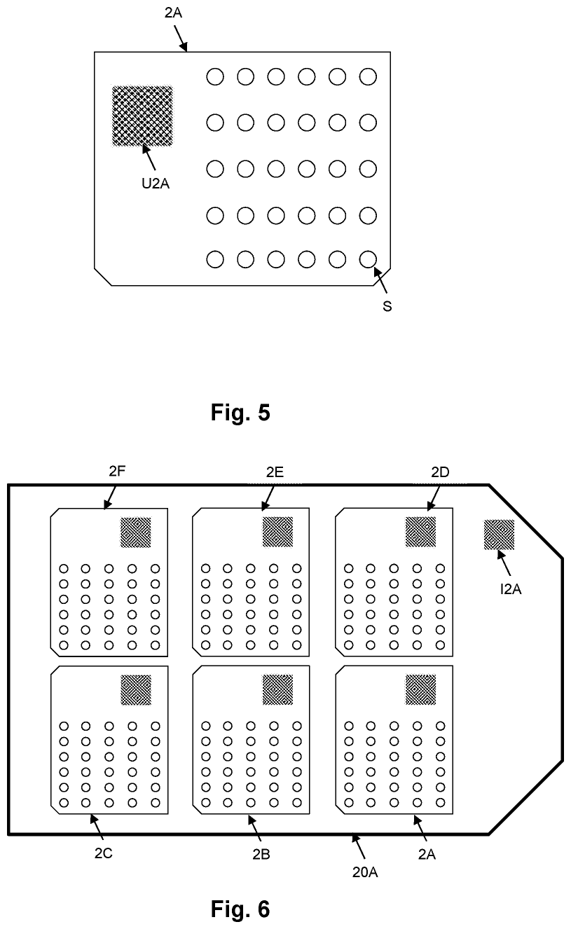

FIG. 5 schematically depicts a first sample plate 2A for the mass spectrometer of FIG. 1.

The first sample plate 2A is generally as described with respect to the first sample 1A of FIG. 3. In this example, the first sample plate 2A has a regular 6×5 array of wells in a first portion of an upper surface thereof, relatively more proximal a first end of the first sample plate 2A, for deposition of respective samples S therein. In this example, the first UDI U2A is a 2D barcode such as a QR code or a Data Matrix.

FIG. 6 schematically depicts a first sample plate holder 20A, for the first sample plate 2A of FIG. 5, for the mass spectrometer of FIG. 1. The first sample holder 20A is generally as described with respect to the sample holder 10A. In this example, the first sample plate holder 20A includes a first identifier 12A of a first set of identifiers 12.

In this example, the first sample plate holder 20A is arranged to hold a subset of a set of sample plates 2, wherein the subset includes N sample plates, wherein N is 6. In this example, six first sample plates 2A, 2B, 2C, 2D, 2E, 2F are held in the first sample plate holder 20.

In this example, the first sample plate holder 20A is arranged to hold a subset of up to 6 sample plates therein and/or thereon, by having a corresponding number of female members particularly machined concavities for receiving the subset of sample plates therein.

In this example, the first sample plate holder 20A is a generally rectangular or square flat plate, formed from stainless steel, having a regular array of 2×3 female members in and/or on a first portion of an upper surface thereof, relatively more proximal a first end of the first sample plate holder 20A, for holding respective sample plates 1 therein.

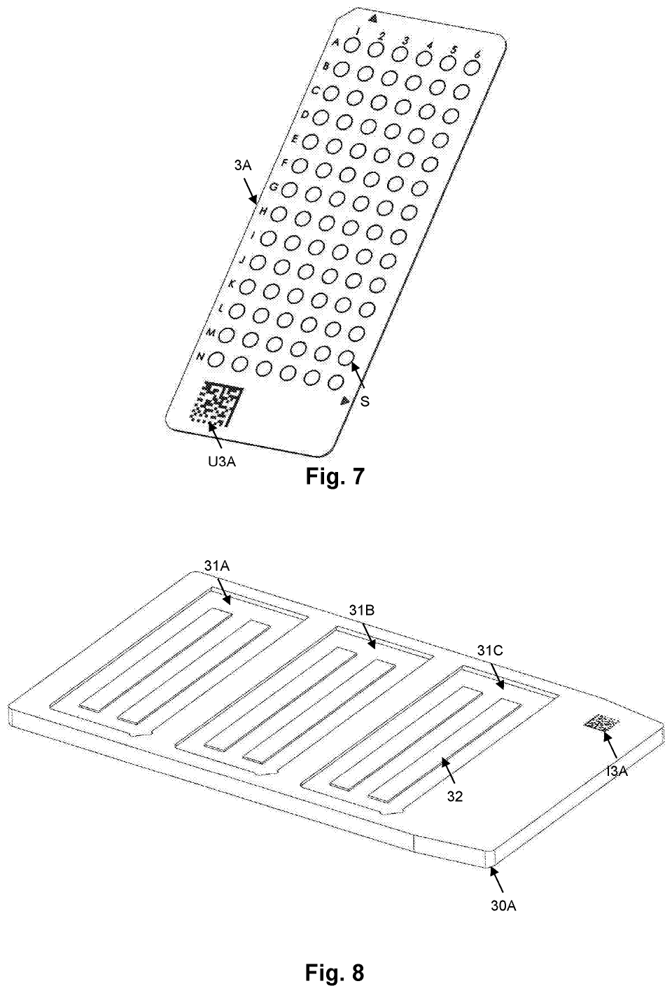

FIG. 7 schematically depicts a first sample plate 3A for the mass spectrometer of FIG. 1. The first sample plate 3A is generally as described with respect to the first sample 1A of FIG. 3. In this example, the first UDI U3A is a 2D barcode such as a QR code or a Data Matrix. In this example, the first sample plate 3A has a regular 6×14 array of wells (i.e. an 84 well plate) in a first portion of an upper surface thereof, relatively more proximal a first end of the first sample plate 3A, for deposition of respective samples S therein. In this example, the first sample plate 3A includes alphanumeric labels to identify positions of the wells by row and column. In this example, the first sample plate 3A has an asymmetric shape, having a reduced number of planes of symmetry, having no planes of symmetry orthogonal to the upper surface.

In this example, a thickness of the first sample plate 3A is 0.3 mm+/−0.03 mm i.e. tightly toleranced. Flatness and parallelism of the first sample plate 3A is within 0.03 mm.

FIG. 8 schematically depicts a first sample plate holder 30A, for the first sample plate 3A of FIG. 7, for the mass spectrometer of FIG. 1. The first sample plate holder 30A is generally as described with respect to the first sample plate holder 10A of FIG. 4.

In this example, the first sample plate holder 30A is a generally rectangular or square flat plate, formed from stainless steel, having a regular array of 1×3 female members 31A, 31B, 31C in and/or on a first portion of an upper surface thereof, relatively more proximal a first end of the first sample plate holder 30A, for holding respective sample plates 3 therein.

In this example, the female members 31A, 31B, 31C each include 2 machined pads 32 to receive the sample plates 3 thereon. In this example, a thickness of the pads 32 is 4.97 mm+0.00 mm/−0.03 mm i.e. very tightly toleranced.

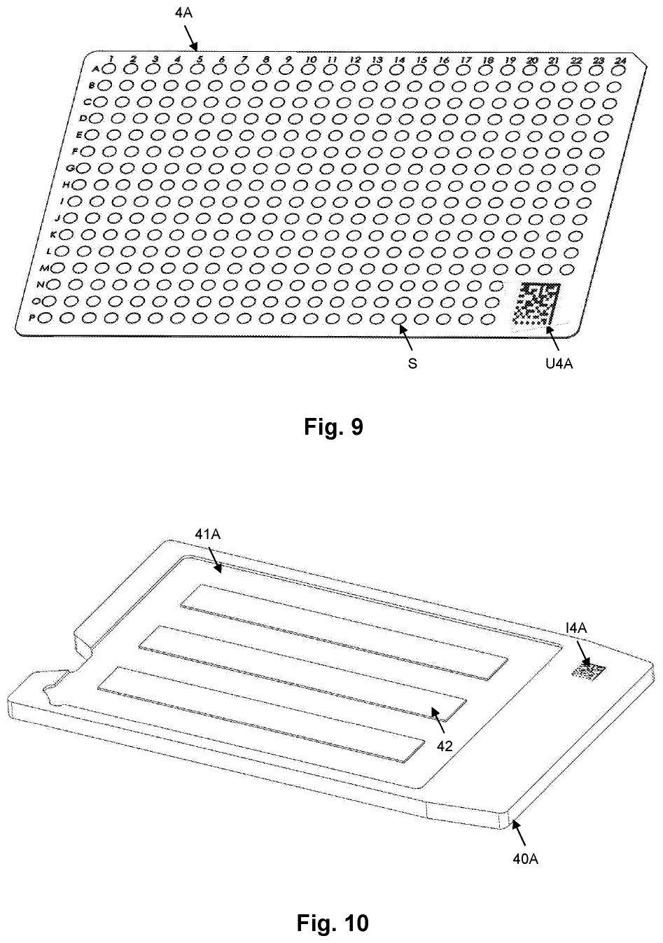

FIG. 9 schematically depicts a first sample plate 4A for the mass spectrometer of FIG. 1.

The first sample plate 3A is generally as described with respect to the first sample 3A of FIG. 7. In this example, the first sample plate 4A has a regular 24×16 array of wells (i.e. a 384 well plate). In this example, the first UDI U4A is a 2D barcode such as a QR code or a Data Matrix.

FIG. 10 schematically depicts a first sample plate holder 40A, for the first sample plate 4A of FIG. 9, for the mass spectrometer of FIG. 1. The first sample plate holder 40A is generally as described with respect to the first sample plate holder 30A of FIG. 8.

In this example, the first sample plate holder 40A is a generally rectangular or square flat plate, formed from stainless steel, having a regular array of 1×1 female members 41A in and/or on a first portion of an upper surface thereof, relatively more proximal a first end of the first sample plate holder 40A, for holding respective sample plates 4 therein.

In this example, the female member 41A each include 3 machined pads 42 to receive the sample plates 4 thereon. In this example, a thickness of the pads 42 is 4.97 mm+0.00 mm/-0.03 mm i.e. very tightly toleranced.

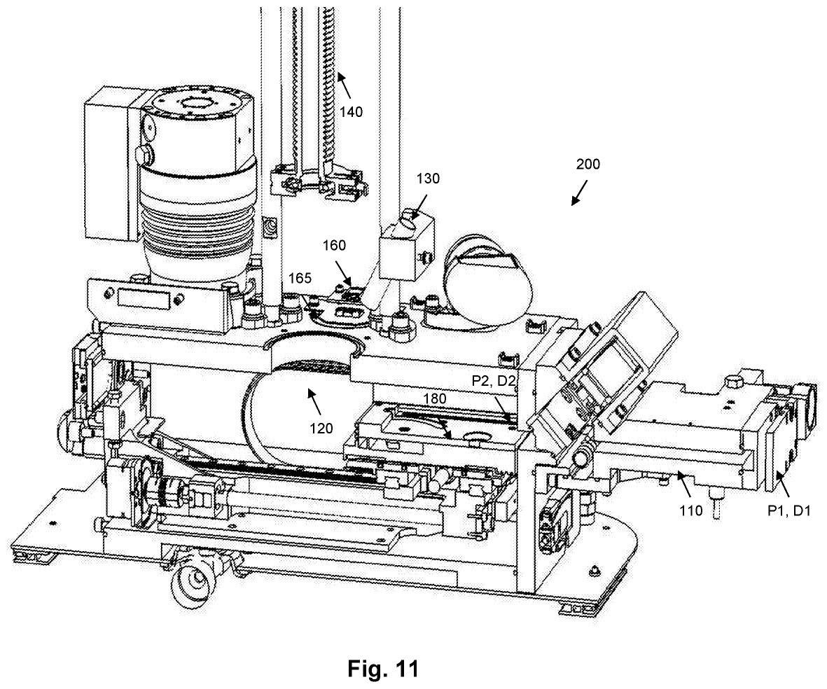

FIG. 11 schematically depicts a perspective, cutaway view of a mass spectrometer 200 according to an exemplary embodiment, generally as described with respect to the mass spectrometer 100 of FIGS. 1 and 2. Like reference signs denote like features.

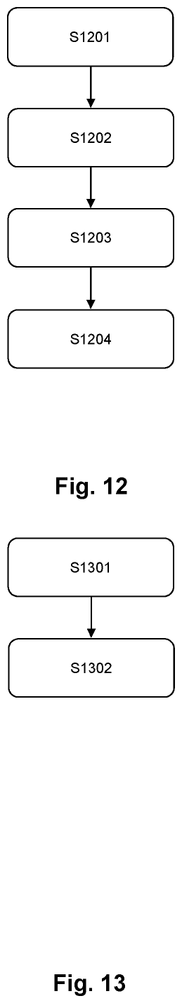

FIG. 12 schematically depicts a method of controlling a mass spectrometer according to an exemplary embodiment.

At S1201, the method comprises arranging the MS in a first arrangement, comprising opening the first door while the second door is closed and receiving a first sample plate of a set of sample plates in the first chamber via the first port, wherein the first sample plate includes a first UDI of a set of UDIs.

At S1202, the method comprises arranging the MS in a second arrangement, comprising closing the first door, wherein the first sample plate is in the first chamber, wherein the second door is closed.

At S1203, the method comprises arranging the MS in a third arrangement, comprising opening the second door, receiving the first sample plate in the second chamber via the second port and closing the second door thereafter.

At S1204, the method comprises imaging, by the imager, the first UDI of the first sample plate, when the MS is arranged in the third arrangement.

FIG. 13 schematically depicts a method of controlling a mass spectrometer according to an exemplary embodiment.

At S1301, the method comprises receiving the first sample plate holder in the set of chambers.

At S1302, the method comprises reading the first identifier of the first sample plate holder received in the set of chambers.

Alternatives

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A mass spectrometer, MS, comprising:
a first chamber, comprising a set of ports closeable by respective doors, for receiving sample plates including respective unique device identifiers, UDIs, therein and/or therethrough, wherein the set of ports includes a first port having a first door and a second port having a second door;
a second chamber, fluidically coupleable with the first chamber via the second port, wherein the second chamber is fluidically coupled to and/or comprises an ion source, an analyser and an ion detector, for mass spectrometry of samples included on the sample plates received therein;
an imager, coupled to the second chamber, configured to image the UDIs of the sample plates; and
a controller configured to control the imager;
wherein the MS is arrangeable in:
a first arrangement, wherein a first sample plate of a set of sample plates is received in the first chamber via the first port, wherein the first door is open and wherein the second door is closed, and wherein the first sample plate includes a first UDI of a set of UDIs;
a second arrangement, wherein the first sample plate is in the first chamber, wherein the first door is closed and wherein the second door is closed; and
a third arrangement, wherein the first sample plate is received in the second chamber via the second port, wherein the second door is closed;
wherein the controller is configured to control the imager to image the first UDI of the first sample plate, when the MS is arranged in the third arrangement, responsive to the MS moving to the third arrangement.

2. The MS according to claim 1, wherein the controller is configured to control the imager to image the first UDI of the first sample plate, in response to sensing closing of the second door, sensing receiving of the first sample plate in the second chamber or sensing a pressure in the second chamber.

3. The MS according to claim 1, wherein the controller is configured to control the imager to image the first UDI of the first sample plate, when the MS is arranged in the third arrangement, before mass spectrometry of the samples included on the first sample plate.

4. The MS according to claim 1, wherein the imager is configured to transmit data corresponding to the first UDI to the controller.

5. The MS according to claim 1, wherein the controller is configured to control mass spectrometry of the samples included on the first sample plate based, at least in part, on information obtained via the first UDI,
wherein the information includes sample plate-specific or sample-specific methods or parameters, for mass spectrometry of one or more of the samples included on the first sample plate.

6. The MS according to claim 1, wherein the controller is configured to control the imager to attempt to image a UDI of a sample plate intermittently or wherein the controller is configured to control the imager to image the first UDI of the first sample plate intermittently.

7. The MS according to claim 1, wherein the controller is configured to store MS data or results of one or more of the samples included on the first sample plate responsive to performing the mass spectrometry of one or more of the samples included on the first sample plate using the first UDI, at least in part, as a key.

8. The MS according to claim 1, wherein the controller is configured to implement a remedial action, in response to a determination that the first UDI is invalid.

9. The MS according to claim 1, wherein the first chamber comprises a first conveyor, for conveying the first sample plate from the first chamber to the second chamber via the second port.

10. The MS according to claim 1, wherein the second chamber comprises a second conveyor, for conveying the first sample plate within the second chamber.

11. The MS according to claim 1, comprising the first sample plate.

12. The MS according to claim 1, wherein the first UDI comprises includes a barcode.

13. The MS according to claim 1, wherein the first sample plate is held in or on a first sample plate holder of a set of sample plate holders.

14. The MS according to claim 13, wherein the first sample plate holder includes a first identifier of a first set of identifiers.

15. The MS according to claim 14, wherein the first identifier includes a visual code.

16. The MS according to claim 13, wherein the first sample plate holder is arranged to hold a subset of the set of sample plates therein or thereon, wherein the subset includes N sample plates, wherein N is a natural number greater than or equal to 1.

17. The MS according to claim 1, wherein the imager is optically coupled to the second chamber.

18. The MS according to claim 17, wherein the imager is optically coupled to the second chamber via an optical coupling.

19. A method of controlling an MS according to claim 1, the method comprising:
arranging the MS in a first arrangement, comprising opening the first door while the second door is closed and receiving a first sample plate of a set of sample plates in the first chamber via the first port, wherein the first sample plate includes a first UDI of a set of UDIs;
arranging the MS in a second arrangement, comprising closing the first door, wherein the first sample plate is in the first chamber, wherein the second door is closed;
arranging the MS in a third arrangement, comprising opening the second door, receiving the first sample plate in the second chamber via the second port and closing the second door thereafter; and
imaging, by the imager, the first UDI of the first sample plate, when the MS is arranged in the third arrangement.

20. A computer comprising a processor and a memory configured to implement, at least in part, a method according to claim 19, a computer program comprising instructions which, when executed by a computer comprising a processor and a memory, cause the computer to perform, at least in part, a method according to claim 19 or a non-transient computer-readable storage medium comprising instructions which, when executed by a computer comprising a processor and a memory, cause the computer to perform, at least in part, a method according to claim 19.
